(19) United States
(12) Patent Application Publication
(10) Pub. No.: US 2018/0093247 A1
(43) Pub. Date: Apr. 5, 2018

(54) STRUCTURE OF INTEGRATED PHOTOCHEMICAL REACTOR

(71) Applicant: CNR - CONSIGLIO NAZIONALE DELLE RICERCHE, Roma (IT)

(72) Inventors: Iginio LONGO, Pisa (IT); Carlo FERRARI, Pisa (IT)

(73) Assignee: CNR - CONSIGLIO NAZIONALE DELLE RICERCHE, Roma (IT)

(21) Appl. No.: 15/559,907

(22) PCT Filed: Mar. 17, 2016
(86) PCT No.: PCT/IB2016/051502

§ 371 Date: Sep. 20, 2017

(30) Foreign Application Priority Data
Mar. 20, 2015 (IT) PI2015A000022

(51) Int. Cl. B01J 19/08; B01J 19/12

(52) U.S. Cl. CPC B01J 19/088; B01J 2219/1215; B01J 19/126; B01J 19/124

(57) ABSTRACT

A photochemical reactor (1) having a hollow container body (10) having a side wall (11) made of a material arranged to contain an excited luminous plasma with electromagnetic fields and defining a closed excitation chamber (12) in which, in use, an excitable material (15) is present in such a way to obtain a discharge of the excited luminous plasma by microwave irradiation. The hollow container body (10) is provided with at least a hollow (20) that protrudes into the excitation chamber (12) and at least a microwave radiation source positioned, in use, in the hollow (20), and arranged to emit radiations in such a way to excite the excitable material (15) producing a luminous plasma.

### FIELD OF THE INVENTION

The present invention relates to the field of photochemical reactions and in particular relates to an innovative photochemical reactor of integrated type.

In particular, the invention relates to a photochemical reactor that does not provide the use of electrodes.

### STATE OF THE ART

As well known, a photochemical reaction is a chemical reaction that is induced and/or accelerated by the light. The energy that is necessary for the development of the chemical reaction is, in fact, provided by the photons that are absorbed by the chemical reagents or different photocatalytic materials, in case they are present.

Among the more known photochemical reactions there are the sterilization processes of gases and fluids. Other photochemical reactions are those that occur in the synthesis processes of particular substances, for example the vitamin D biosynthesis.

Many different typologies of photochemical reactors exist within which the photochemical reactions are conducted.

A first photochemical reactor of prior art comprises a tube made of fused quartz having a coil shape and positioned around a UV lamp. This type of photochemical reactor has an important drawback. In particular, the internal diameter of the tube made of quartz, of which the coil is made, cannot be miniaturized for structural reasons. Therefore, if the reagents consist of a solution of highly opaque liquids, that means absorbent to UV, VUV radiations, as almost in all the reactions of interest of the analytical chemistry happens, the radiations are not able to penetrate within the mass of reagents flowing in the tube, consequently decreasing the process efficiency.

Another drawback is represented by the position of the coil. This is, in fact, provided outside the source of optical radiation.

The above disclosed solution causes reflections of the optical radiations at the external surface of the coil. Therefore, in practice, these optical radiations are not involved in the process.

A further solution provides the use of a source of radiations consisting of an arc lamp, i.e. a lamp with metal electrodes arranged into contact with the plasma and between which a discharge is produced. The main drawbacks of this technical solution are a short life of the lamp, high production costs, the unavoidableness to have the “sputtering”, i.e. a cathode pulverization, and the deposit of metal vapours on the internal walls of the lamp. Further drawbacks of this solution derive from the use of high-voltage electrodes, for isolation reasons and safety of use, and for the impossibility of using reactive metal vapours (like, for example, S, K, I, Na, etc.) for the production of spectral emissions of particular interest, because, as well known, these vapours are particularly reactive and provides chemical attacks of the electrodes.

A solution to the above problem is disclosed in DE10236717. In this case a photochemical reactor is provided comprising a reaction chamber that is defined by external walls and contains a plasma. The photochemical reactor is equipped, furthermore, with 2 electrodes arranged to produce an electromagnetic field within the reaction chamber. More precisely, the electrodes cause the discharge of the plasma contained within the reaction chamber in such a way to produce a UV light fed by a microwave radiation (MW). In order to avoid the drawback that has been disclosed with reference to the previous case, and in particular the direct contact of the electrodes with the plasma, which would cause, over time, a deterioration of the electrodes, jeopardizing, and therefore, the effectiveness and the life of the device, in this case the electromagnetic and microwave radiations are introduced within the reaction chamber by means of a waveguide. However, also this solution is not able to satisfactorily overcome the above disclosed drawbacks because of the use of electrodes.

### SUMMARY OF THE INVENTION

It is then an object of the present invention to provide a photochemical reactor that is able to overcome the above disclosed drawbacks of the prior art solutions.

It is, in particular, an object of the present invention to provide a photochemical reactor that allows to obtain a higher power density on the sample with respect to the solutions of prior art and therefore a higher efficiency of the reaction.

It is, furthermore, an object of the present invention to provide a photochemical reactor that allows to considerably reduce the reaction times with respect to the solutions of prior art.

It is another object of the present invention to provide a photochemical reactor that allows to reduce the amount of unused power of the radiation that is used.

It is further object of the present invention to provide a photochemical reactor that is able to homogeneously and uniformly treat the mass of reagents.

It is still another object of the present invention to provide a photochemical reactor that is highly versatile, because it can be used for a large range of reactions, and at the same time that is extremely reliable.

It is a particular object of the present invention to provide a photochemical reactor that is resistant to very high temperatures.

It is still another object of the present invention to provide a photochemical reactor that is economically than the photochemical reactors of prior art and that have a much longer average life than the same.

These and other objects are achieved by the structure of photochemical reactor, according to the invention, comprising:
a hollow container body having a side wall in un chemically inert material and arranged to contain un excited luminous plasma with electromagnetic fields e defining a closed excitation chamber in which an excitable material is present, in use, in such a way to obtain a discharge of said excited luminous plasma by microwaves irradiation, said hollow container body being provided with:
   at least a hollow which protrudes into said excitation chamber;
   at least a source of microwave radiation positioned, in use, in said hollow, said source of microwave radiation arranged to emit said radiation in such a way to excite said excitable material producing said luminous plasma arranged to emit an optical radiation ad a predetermined wavelength;
whose main characteristic is that the hollow is delimited by a wall that protrudes into the excitation chamber, whereby the source of microwave radiation is not into contact with the plasma and that is provided, furthermore, a reaction tube which, in use, passes through said excitation chamber in such a way to be immersed in said luminous plasma, said reaction tube arranged to contain, in use, predetermined chemical reagents and made of a material that is transparent to said predetermined optical radiation emitted by said luminous plasma, in such a way that said optical radiation is arranged to hit said chemical reagents in such a way to induce a predetermined photochemical reaction.

In particular, the photochemical reactor, according to the invention, does not provide the use of electrodes. Therefore, the present invention allows to avoid the drawbacks of the prior art solutions and in particular the deterioration of the electrodes for their direct contact with the plasma.

Advantageously, the wall of the hollow container body is made of a material transparent to a predetermined electromagnetic radiation.

In particular, the reaction container is fixed to said side wall of said hollow container body, for example by welding, in such a way to assure a complete isolation of the excitation chamber from the outside environment.

In particular, the, or each, hollow is a dead hole delimited by a wall that protrudes into said excitation chamber from the side wall of said hollow container body. In a different embodiment of the invention, instead, the hollow is a through hole that therefore passes right through the hollow container body.

More in detail, the wall of the hollow can coincide with the side wall of the hollow container body, or alternatively protrudes beyond the side wall of the hollow container body for a predetermined length.

Advantageously, a plurality of hollows is provided, each hollow of said plurality arranged to house, in use, a respective microwave source.

According to an embodiment of the invention, a plurality of reaction tubes is provided, each reaction tube of said plurality being immersed, in use, in said luminous plasma and arranged to contain respective chemical reagents of a predetermined photochemical reaction.

Preferably, the, or each, microwave source is a coaxial dipole antenna.

In particular, the, or each, reaction tube is associated to a shield configured in such a way to selectively blocks said microwaves produced by said, or each, microwave source, but to allow the passage of at least a predetermined electromagnetic radiation of interest emitted by said plasma.

In particular, the electromagnetic radiation of interest is selected from the group consisting of: the ultraviolet radiation, the visible radiation, the infrared radiation, or the vacuum ultraviolet radiation, or any combination thereof. In this way, it is possible to selectively induce said photochemical reaction in the reagents contained in said, or each, reaction tube.

For example, the shield can have a reticular structure.

Preferably, la reticular structure of the shield is made of metal.

In a different embodiment of the invention, the reaction tube is part of a double pipe.

More precisely, the double pipe comprises:
the reaction tube containing said chemical reagents;
a cooling duct coaxially arranged to the reaction tube and containing a cooling fluid, said cooling fluid arranged to cool the mass of the chemical reagents during the development of the photochemical reaction, in such a way to control the temperature of the photochemical reaction.

In an embodiment of the invention, the reaction tube is provided as a part of a circuit comprising a pumping device of the reagents, said pumping device arranged to produce a flow of material that passes, in use, through said reaction tube. In this case, the chemical reagents can flow through the circuit.

In a different embodiment provided by the invention, the, or each, reaction tube has a coil shape in such a way to increase the exchange surface through which the optical radiation emitted by the luminous plasma causes the chemical reagents to react photochemically.

The hollow container body can be made of a transparent fused quartz.

Advantageously, the, or each, reaction tube is made of a transparent fused quartz.

In particular, the transparent fused quartz, since it is transparent to the optical radiation emitted by the plasma, allows, on one hand, the optical radiation to reach the mass of chemical reagents that are present into the reaction tube and, on the other hand, it allows the development of photochemical reactions producing a high energy, in other words, it allows to operate in a large range of temperatures, thanks to the ability to be resistant to very high temperatures.

### BRIEF DESCRIPTION OF THE DRAWINGS

The invention will be now shown with the following description of an exemplary embodiment, exemplifying but not limitative, with reference to the attached drawings in which:

FIG. 1A diagrammatically shows in an elevational side view a first embodiment of a photochemical reactor, according to the invention;

FIG. 2A diagrammatically shows the photochemical reactor of FIG. 1A in a longitudinal section view;

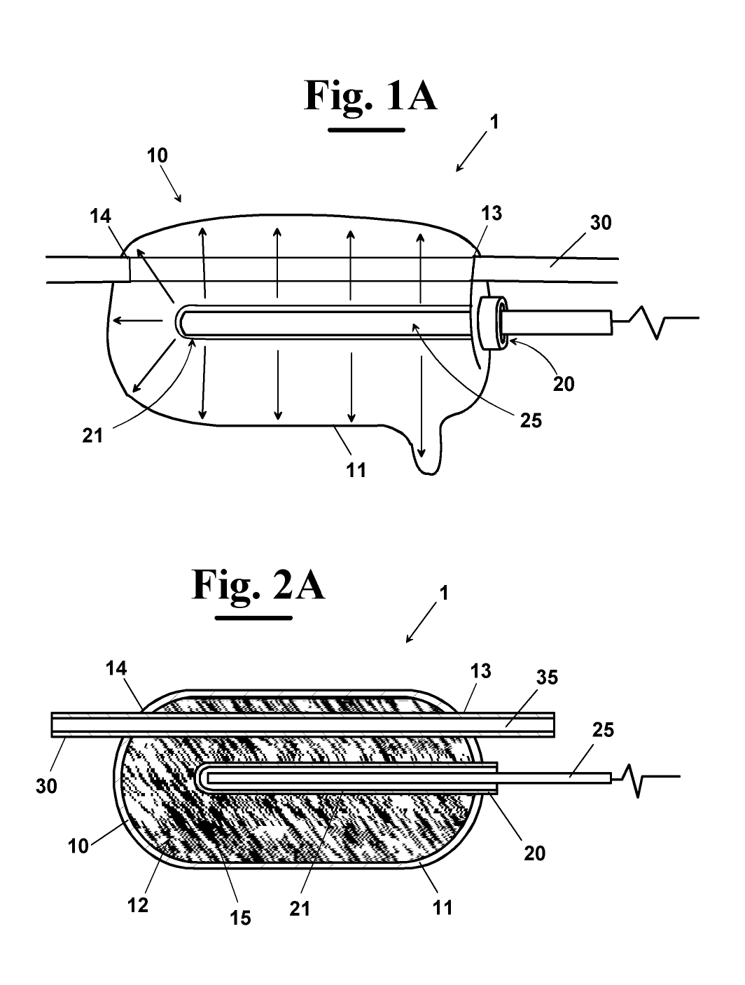

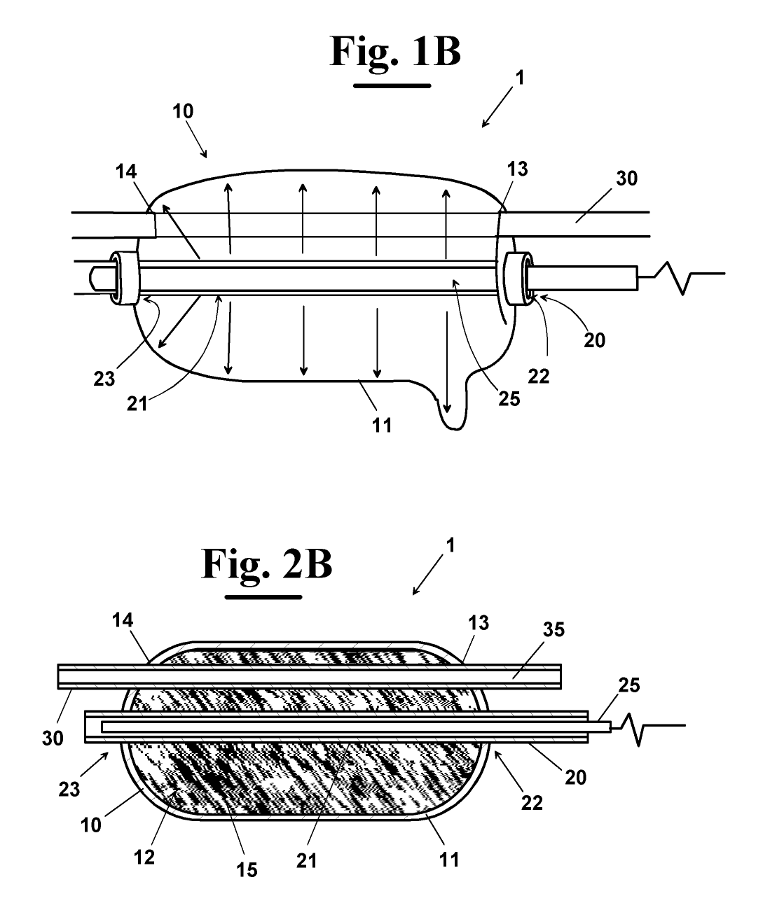

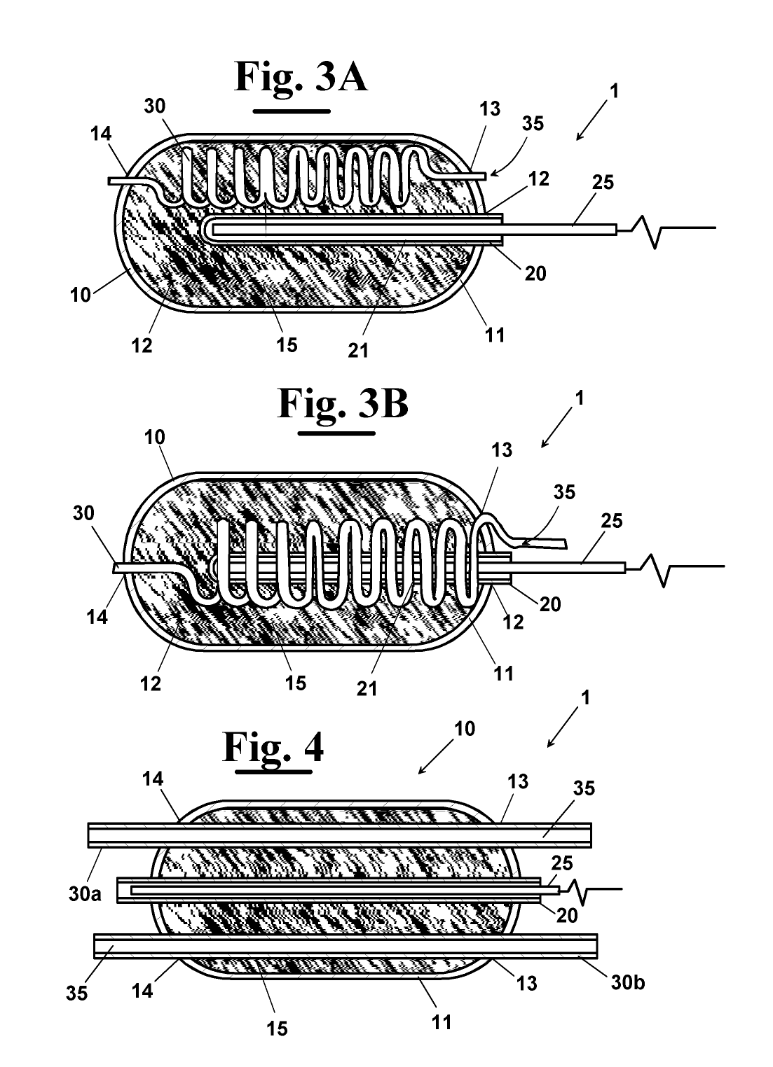

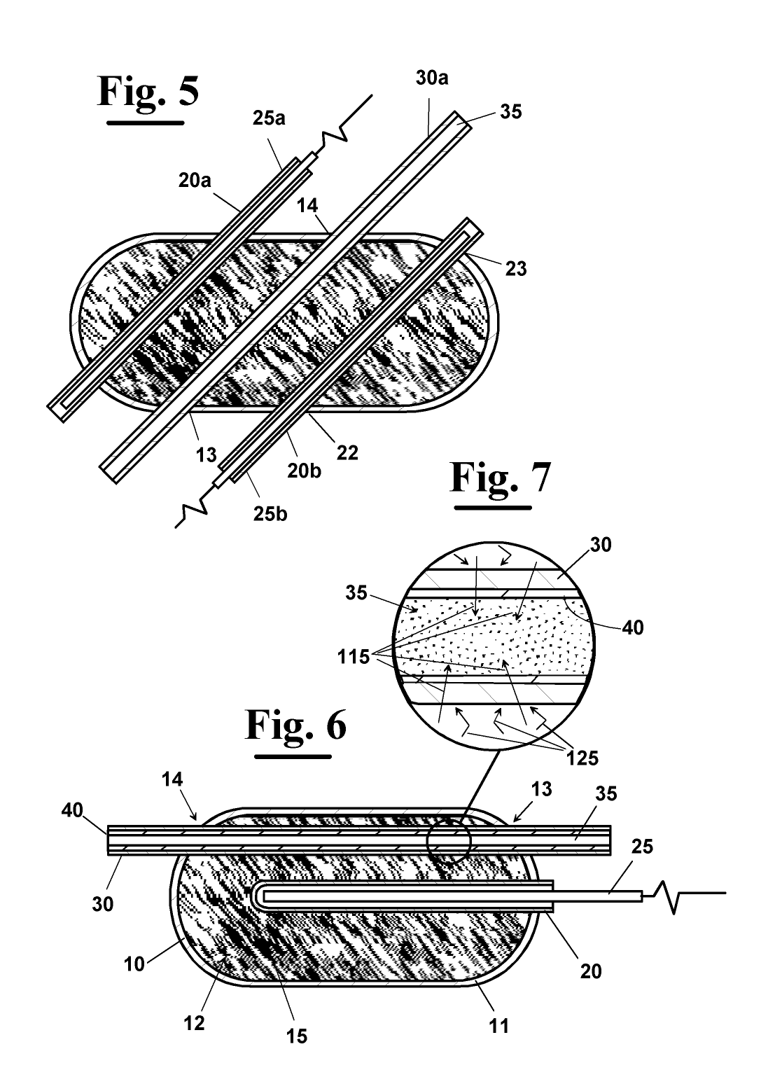

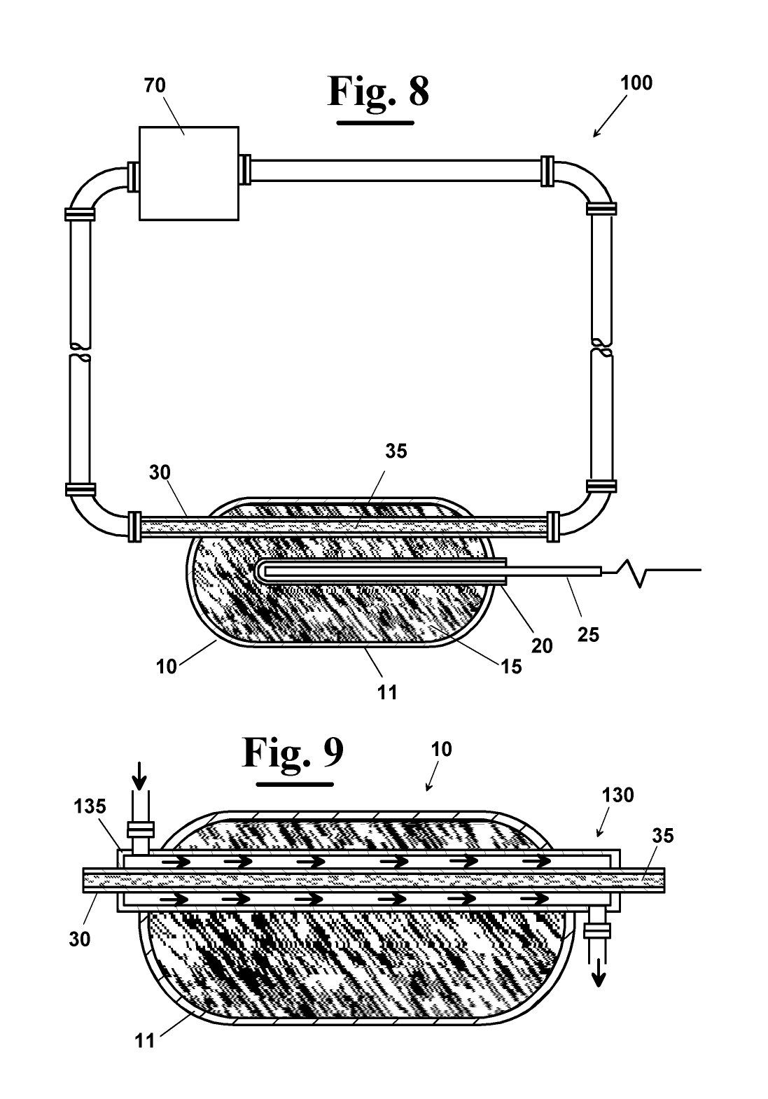

FIGS. 1B and 2B diagrammatically show in a elevational side view and in a longitudinal section view, respectively, an alternative embodiment of the photochemical reactor of FIGS. 1A and 2A, in which the hollow, which houses the antenna, is a through hole provided in the hollow container body;

FIGS. 3A to 6 show in longitudinal section views some alternative embodiments, according to the invention, of the photochemical reactor of FIG. 2;

FIG. 7 shows in detail an enlargement of the embodiment of FIG. 6 that provides the use of a shield associated to the reaction tube;

FIGS. 8 and 9 show further embodiments of the photochemical reactor of FIG. 1.

### DETAILED DESCRIPTION OF THE INVENTION

With reference, for example, to FIGS. 1A and 2A, a structure of photochemical reactor 1, according to the invention, comprises a hollow container body 10, in particular a bulb, having a side wall 11 made of a chemically inert material, for example glass.

More precisely, the material can be transparent to the optical radiation, from the infrared to the vacuum ultraviolet radiation (VUV), and to the microwaves, for example fused quartz. Alternatively, the material can be opaque to the electromagnetic radiation, because the fields exciting the plasma does not come from the outside.

The side wall 11 delimits a closed excitation chamber 12 within which an excitable material 15 is contained, for example, a mixture of argon and mercury. The photochemical reactor 1 is provided with at least a hollow 20 made of a material that is transparent to the microwaves, within which, in use, is arranged a source of microwave radiation, preferably a coaxial dipole antenna 25. This is arranged to emit microwaves in such a way to excite the material that is contained within the excitation chamber 12. The excitation of the material 15 produces a luminous plasma, which emits an optical radiation having a predetermined wavelength, in particular ultraviolet, visible, or infrared, radiation to which the material in which the hollow container body 10 is made can be transparent, as above disclosed and analogously to what is described in detail in the patent EP1449411 in the name of the same Applicant.

According to the invention, the photochemical reactor comprises, furthermore, at least a reaction tube 30 within which predetermined chemical reagents are provided. More precisely, the reaction tube 30 is fixed, for example welded, to the side wall 11 of the hollow container body 10, in such a way to assure that the excitation chamber 12 is isolated from the external environment. More in detail, the reaction tube 30 has, in use, at least a portion that is immersed in the luminous plasma.

Since the reaction tube 30 is made of a material that is transparent to the electromagnetic radiation produced by the luminous plasma, for example transparent fused quartz, the optical radiation emitted by the plasma is free to reach the reagents 35 contained within the reaction tube 30 inducing a predetermined photochemical reaction.

In particular, the present invention allows to arrange the chemical reagents 35, in which the photochemical reaction is induced, directly within the source of optical radiation, i.e. the plasma. Therefore, differently from the solutions of prior art, the radiations penetrate within the reaction tube 30 from every directions and making, therefore, particularly efficient the chemical activation of the reaction. Therefore, with respect to the known solutions, for the same energy that has been absorbed for exciting the material 15, i.e. for the same energy emitted by antenna 25, the sample, i.e. the mass of reagents, is subjected to a higher density of radiation power. This allows to reach a higher yield with respect to the known solutions.

Furthermore, the mass of chemical reagents 35 is irradiated from every direction and therefore a high uniformity in the treatment of the mass is achieved. This latter aspect is very important for the high value of the extinction coefficient of the VUV radiation in many of the materials that are used in the reactors of prior art that obliges to use very small volumes, or to accept a non-uniform treatment.

The possibility to be able to make both the reaction tube 30 and the hollow body 10 in transparent fused quartz allows to use the reactor 1 also for photochemical reactions that develops at high temperatures thus increasing the range of photochemical reactions that can be conducted using the reactor 1 according to the invention. This constructive solution allows, furthermore, to reduce as desired the thickness of the wall of the reaction tube 30 and therefore to further optimize the process.

As shown, for example, in FIGS. 1A and 2A, the hollow 20 can be substantially a dead hole delimited by a wall 21 protruding into the excitation chamber 12 from the side wall 11 of the hollow container body 10.

In a different embodiment of the invention shown in FIGS. 1B and 2B, instead, the hollow 20 is a through hole which crosses all the side wall 11 of the container body 10 between an inlet mouth 22 and an outlet mouth 23. More in detail, in the first case, the wall of the hollow 20 coincides with the wall of the hollow container body 10, whilst in the second case, the wall 21 of the hollow 20, for example made of fused quartz, or other transparent material, protrudes beyond the wall 11 of the hollow container body 10 for a predetermined length. In this latter case, the wall 21 of the hollow 20 is provided welded to the side wall 11 of the container body 10, analogously to what has been disclosed for the reaction tube 30. As diagrammatically shown in FIGS. 2B, 4 and 5, furthermore, the hollow 20 can be a portion of an open tube, i.e. that is not closed neither at the first end nor at the other end.

In the embodiments of FIGS. 3A and 3B, the, or each, reaction tube 30 has a coil shape. More precisely, in the case of FIG. 3A, the coil is arranged at a predetermined distance from the hollow 20, which houses the antenna 25, whilst in the case of FIG. 3B, the coil develops around the hollow 20. In this latter case all the electromagnetic, optical and microwave radiations, that are present in the plasma act on the reaction with axial rotation symmetry.

This solution allows, in particular, to increase the exchange surface between the mass of the chemical reagents and the luminous plasma and, thus, the optical radiation of interest.

In the different embodiment of the invention of FIG. 4, instead, a plurality of reaction tubes 30 is provided, for example 2 reaction tubes 30a and 30b, each of which immersed, in use, in the luminous plasma and arranged to contain respective chemical reagents, that are not necessarily different. In this way, it is possible to optimize the available volume increasing the yield of the photochemical reactor 1.

In FIG. 5, it is, instead, illustrated an embodiment which provides a plurality of hollows 20, in particular a first and a second hollow 20a e 20b, each of which arranged to house, in use, a respective microwave source 25a and 25b. In this case, thanks to the use of 2 microwave antennas 25, a higher radiation power is emitted in the excitable material 15 that is then excited in a more uniform way.

It is to be noted that, even though in the example of FIG. 5 is shown the case in which a hollow, and precisely the first hollow 20a, is a dead hole, whilst another hollow, and precisely the second hollow 20b, is a through hole passing through the container body 10 between an inlet mouth 22 and an outlet mouth 23, it is also provided the possibility, not shown in the figure for reasons of simplicity, that all the hollows 20 can be dead holes, or through holes, or that a part of the hollows can be dead holes and another part can be through holes.

In the exemplary embodiment shown in FIGS. 6 and 7, the reaction tube 30 is associated to a shield 40 configured in such a way to selectively block the microwaves 125 produced by the, or each, microwave source 25, but to allow the passage of the electromagnetic radiation of interest 115, for example the UV radiation and/or the VUV radiation and/or the IR radiation, or the visible radiation. More in detail, the shield 40 can be positioned outside the external wall of the reaction tube 30, as shown in detail in FIGS. 6 and 7, or within it.

In this way, it is, therefore, possible to selectively induce a photochemical reaction in the reagents 35 that are contained within the reaction tube 30. For example, the shield 40 can have a reticular structure and can be made of a metal material.

In the further embodiment of FIG. 8, the, or each, reaction tube 30 can be part of a circuit 100 comprising a pumping device 70 of the reagents 35. In particular, the pumping device 70 is arranged to produce a flow of chemical reagents which, in use, passes through the circuit 100 up to reach the reaction tube 30.

In a different embodiment of the invention, the reaction tube 30 is part of a double pipe 130 comprising a cooling duct 135 that is coaxially arranged to the reaction tube 30, in particular outside the same, and containing a predetermined cooling fluid (FIG. 9). In this way, it is possible to control the temperature of the photochemical reaction that occurs in the reaction tube 30, avoiding, in particular, that it can reach too much high temperatures.

The foregoing description exemplary embodiments of the invention will so fully reveal the invention according to the conceptual point of view, so that others, by applying current knowledge, will be able to modify and/or adapt for various applications such embodiment without further research and without parting from the invention, and, accordingly, it is therefore to be understood that such adaptations and modifications will have to be considered as equivalent to the specific embodiments. The means and the materials to realise the different functions described herein could have a different nature without, for this reason, departing from the field of the invention. It is to be understood that the phraseology or terminology that is employed herein is for the purpose of description and not of limitation.

1. A photochemical reactor (1) comprising:
a hollow container body (10) having a side wall (11) in a chemically inert material and arranged to contain an excited luminous plasma con electromagnetic fields and defining a closed excitation chamber (12) in which, in use, an excitable material (15) is present in such a way to obtain a discharge of said excited luminous plasma by microwave irradiation, said hollow container body (10) being provided with:
a hollow (20) which protrudes into said excitation chamber (12);
a source of microwave radiation positioned, in use, in said hollow (20), said source of microwave radiation (25) arranged to emit said radiation, in such a way to excite said excitable material (15) producing said luminous plasma arranged to emit an optical radiation having a predetermined wavelength;
wherein said hollow (20) is delimited by a wall (21) which protrudes into said excitation chamber (12), whereby said source of microwave radiation (25) is not into contact with said plasma; and
wherein a reaction tube (30) is, furthermore, provided arranged to pass through, in use, said excitation chamber (12), in such a way to be immersed in said luminous plasma, said reaction tube (30) arranged to contain, in use, predetermined chemical reagents (35) and being made of a material transparent to said predetermined optical radiation emitted by said luminous plasma, in such a way that said optical radiation is arranged to hit said chemical reagents (35) in such a way to induce a predetermined photochemical reaction.

2. The photochemical reactor (1) according to claim 1, wherein said reaction container (30) is fixed to said side wall (11) of said hollow container body (10), in such a way to assure a complete isolation of said excitation chamber (12) from the outside environment.

3. The photochemical reactor (1) according to claim 1, wherein said hollow (20) is a dead hole delimited by a wall (21) which protrudes into said excitation chamber (12) from said side wall (11) of said hollow container body (10).

4. The photochemical reactor (1) according to claim 1, wherein said hollow (20) is a through hole arranged to pass through said side wall of said hollow container body (10) between an inlet mouth (22) and an outlet mouth (23).

5. The photochemical reactor (1) according to claim 1, wherein a plurality of hollows (20) is provided, wherein each hollow (20) of said plurality of hollows is arranged to house, in use, a respective microwave source (25).

6. The photochemical reactor (1) according to claim 1, wherein a plurality of reaction tubes (30) is provided, each reaction tube (30) of said plurality of reaction tubes is immersed, in use, in said luminous plasma and arranged to contain respective chemical reagents of a predetermined photochemical reaction.

7. The photochemical reactor (1) according to claim 1, wherein said microwave source (25) is a coaxial dipole antenna.

8. The photochemical reactor (1) according to claim 1, wherein said reaction tube (30) is associated to a shield (40) configured in such a way to selectively block said microwaves produced by said microwave source (25), but to allow the passage of a predetermined electromagnetic radiation of interest emitted by said plasma.

9. The photochemical reactor (1) according to claim 7, wherein said electromagnetic radiation of interest is selected from the group consisting of:
ultraviolet radiation;
visible radiation;
infrared radiation;
vacuum ultraviolet radiation; and
a combination thereof.

10. The photochemical reactor (1) according to claim 7, wherein said shield (40) has a reticular structure.

11. The photochemical reactor (1) according to claim 7, wherein said shield (40) is made of metal.

12. The photochemical reactor (1) according to claim 1, wherein said reaction tube (30) is part of a double pipe (130).

13. The photochemical reactor (1) according to claim 11, wherein said double pipe (130) comprises:
said reaction tube (30) containing said chemical reagents (35);
said cooling duct (130) axially arranged along said reaction tube (30) and containing a cooling fluid, said cooling fluid arranged to cool the mass of chemical reagents (35) during the development of the photochemical reaction, in such a way to control the temperature of the photochemical reaction.

14. The photochemical reactor (1) according to claim 1, wherein said reaction tube (30) is provided as a part of a circuit (100) comprising a pumping device (70) arranged to produce a flow of material comprising said reagents (35) which, in use, passes through said reaction tube (35).

15. The photochemical reactor (1) according to claim 1, wherein said reaction tube (30) has a coil shape, in such a way to increase the exchange surface through which said optical radiation emitted by said luminous plasma induce said photochemical reaction in said chemical reagents (35).

16. The photochemical reactor (1) according to claim 1, wherein said side wall (11) of said hollow container body (10) is made of a material that is transparent to a predetermined electromagnetic radiation.

17. The photochemical reactor (1) according to claim 1, wherein said hollow container body (10) is made of transparent fused quartz.

18. The photochemical reactor (1) according to claim 1, wherein, said reaction tube (30) is made of transparent fused quartz.
